(19) United States
(12) Patent Application Publication
(10) Pub. No.: US 2016/0123450 A1
(43) Pub. Date: May 5, 2016

(54) BALANCE SHAFT AND INTERNAL COMBUSTION ENGINE

(71) Applicants: Richard CORBETT, Fondettes (FR); Benoît HAUVESPRE, Saint Etienne de Chigny (FR); Julien MAFFUCCI, Pernay (FR)

(72) Inventors: Richard CORBETT, Fondettes (FR); Benoît HAUVESPRE, Saint Etienne de Chigny (FR); Julien MAFFUCCI, Pernay (FR)

(73) Assignee: AKTIEBOLAGET SKF, Goteborg (SE)

(21) Appl. No.: 14/923,521

(22) Filed: Oct. 27, 2015

(30) Foreign Application Priority Data
Oct. 30, 2014 (FR) 1460460

(51) Int. Cl. F16H 53/02

(52) U.S. Cl. CPC F16H 53/02

(57) ABSTRACT

A balance shaft adapted to be rotated by a crankshaft of an internal combustion engine. The balance shaft is equipped with bearings in order to be mounted in a freely rotatable manner in a frame of the internal combustion engine, and with a cam for interaction with a cam follower roller for a fuel injection pump. At least one of the bearings is a bearing with a double row of rolling elements.

### CROSS REFERENCE TO RELATED APPLICATION

This is a Non-Provisional Patent Application, filed under the Paris Convention, claiming the benefit of France (FR) Patent Application Number 1460460, filed on 30 Oct. 2014 (30.10.2014), which is incorporated herein by reference in its entirety.

### FIELD OF THE INVENTION

The present invention relates to a balance shaft and an internal combustion engine comprising at least one balance shaft.

### BACKGROUND OF THE INVENTION

Internal combustion engines may comprise balancing systems which make it possible to compensate for engine vibrations due to the movement of the pistons. An internal combustion engine sometimes comprises a single balance shaft, but more generally two balance shafts rotated in phase opposition by, in general, a gear of the crankshaft of the internal combustion engine, or sometimes a chain or a belt. Balance shafts generally comprise at least one eccentric mass which gives rise to radial and axial loads which increase with the speed of rotation of the balance shafts.

The balance shafts are generally mounted in supports of the internal combustion engine via ball bearings, needle bearings or roller bearings. It is known in particular from document US-A-2011/0247581 that the balance shafts can be equipped with bearings with a single row of balls. Such bearings have a non-controllable axial play which will generate a high degree of noise and vibration and have a reduced service life when they are used to support balance shafts.

It is known from document U.S. Pat. No. 7,823,567 B2 that a balance shaft can be equipped with a cam for interaction with a cam follower roller for an internal combustion engine fuel injection pump. Integrating a cam in a balance shaft imposes limitations, concerning the axial play of the balance shaft, to which it is difficult to respond, especially when considering the axial forces generated by the helical-profile gears of the crankshaft. Specifically, a cam follower roller does not readily accommodate forces transverse to its longitudinal axis, such forces having the effect of greatly reducing its service life, or sometimes even causing it to break in operation.

Patent FR 2 913 739 describes a method for manufacturing paired bearings.

### SUMMARY OF THE INVENTION

The drawbacks mentioned are intended to be remedied by the invention by providing a new internal combustion engine in which the balance shaft or shafts equipped with a cam are supported more reliably and rigidly in rotation than in the prior art.

Accordingly, the invention relates to a balance shaft adapted to be rotated by a crankshaft of an internal combustion engine, the balance shaft being equipped with bearings in order to be mounted in a freely rotatable manner in a frame of the internal combustion engine. The balance shaft comprises a cam for interaction with a cam follower roller for an internal combustion engine fuel injection pump.

This internal combustion engine is characterized in that at least one of the bearings is a bearing with a double row of rolling elements comprising two bearings with one row of rolling elements paired with one another. By virtue of the invention, the axial play of the bearings which support the rotation of the balance shafts can be reduced or eliminated, thereby making it possible to reduce or eliminate the axial movement of the shaft, and also the noise produced by the bearings, and to reduce the wear of the cam follower roller and of its rolling track and to extend their service life.

According to the advantageous but non-obligatory aspects of the invention, such an internal combustion engine may incorporate one or more of the following features, taken in any technically admissible combination: the rolling elements are balls, rollers or needles. Moreover, the bearings may be of the type with deep grooves, in particular with three or four points of contact, and/or of the type with straight contacts and/or of the type with angular contacts.

According to one preferred embodiment, the bearings with one row of rolling elements comprise a first ring and a second ring manufactured in such a way that there is an axial spacing between the axial surfaces of the first ring and of the second ring in a configuration without axial forces. Preferably, these bearings with one row of rolling elements are paired such that the two bearings with one row of rolling elements, constituting one of the bearings with a double row of rolling elements, have complementary axial spacings.

According to one preferred embodiment, the bearings with a single row of balls are deep-groove ball bearings the rings of which comprise a toroidal circular groove forming a raceway. Balls are arranged between the raceways and are held with a regular circumferential spacing by a cage. The bearing is mounted with a certain radial and axial internal play, which depends on the diameter of the groove bottoms of the rings, on the diameter of the balls, and on the radius of the raceways in cross section through an axial plane.

The internal play of the bearing is manifested by the possibility of a slight radial movement exerted on one ring with respect to the other, under the action of a radial or axial force exerted on one of the rings.

By virtue of the capacity to withstand large axial loads, the invention allows the combination of a cam with a helical-profile gear on the same balance shaft.

In order to pair the bearings, there are manufactured and selected the bearings which, when they are arranged side by side and face against face, form an assembly which has an axial play close to zero and a certain angle of contact between the balls and the raceways in order to be able to function while withstanding both a radial load and an axial load.

The manufacture of the bearings with one row of balls may include a grinding step to reduce the width of one of the rings, which are first of all manufactured with an equal axial width. Width is understood to mean the axial dimension from one radial end surface to the other.

The assembly thus formed forms a rolling bearing functioning with an axial play very close to zero and capable of withstanding axial and radial loads.

According to one embodiment of the invention, the bearings allowing the rotation of the balance shaft are angular-contact bearings.

In another embodiment of the invention, the bearings allowing the rotation of the balance shaft are straight-contact bearings.

In another embodiment of the invention, the bearings allowing the rotation of the balance shaft are of the type with deep grooves, in particular of the type with three or four points of contact.

According to one embodiment, the actual axial spacings are measured for a plurality of the bearings and the bearings having complementary or zero spacings are paired. The selection of the bearings for pairing purposes may additionally be carried out by measuring the relative spacings of the terminal radial surfaces of the rings and by applying opposed axial forces.

### BRIEF DESCRIPTION OF THE FIGURES

The invention will be better understood and other advantages thereof will become more clearly apparent in the light of the following description of an internal combustion engine in accordance with its principle, given by way of non-limiting example with reference to the appended drawings, in which:

FIG. 1 is a view in section of an internal combustion engine according to the invention; and

FIG. 2 is a larger-scale view of the detail II of FIG. 1

### DETAILED DESCRIPTION OF THE EMBODIMENTS

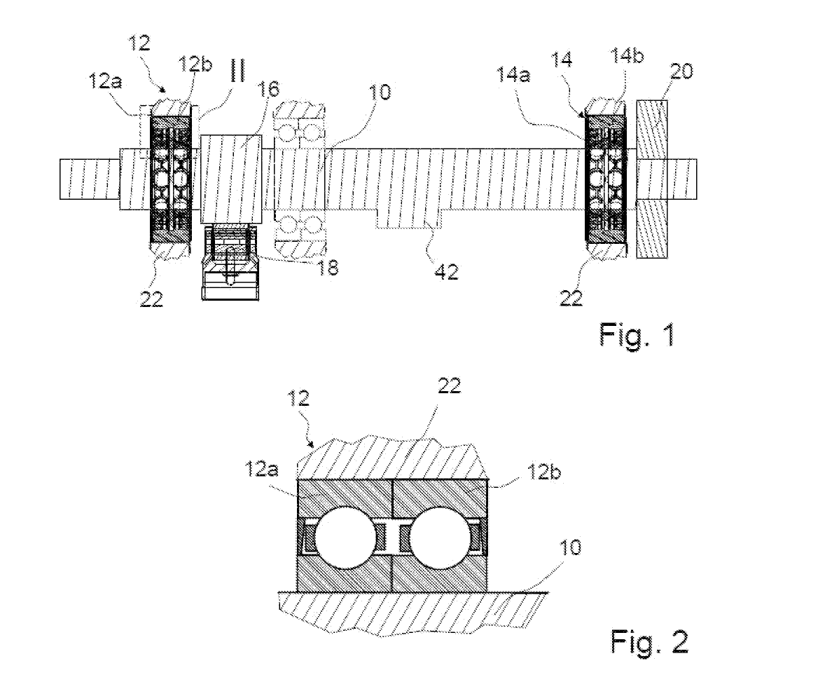

A balance shaft 10 of an internal combustion engine M is shown in FIG. 1. The engine M comprises or receives a frame B. The internal combustion engine M comprises a crankshaft (not shown) of which one end is provided with a gear.

The gear of the crankshaft engages with a gear 20 of the balance shaft 10, which is mounted in a freely rotatable manner in at least two supports 22 of the frame B. The rotation of the balance shaft 10 in the supports is permitted by at least two bearings 12 and 14 of which at least one has a double row of rolling elements. These at least two bearings are arranged on a first side of the gear 20 with a helical profile.

In one embodiment (not shown) of the invention, one of the two bearings 12, 14 has a double row of rolling elements, while the other bearing 12, 14 has a single row of rolling elements, being for example a needle bearing.

In one embodiment (not shown) of the invention, the balance shaft is driven not by a gear but by a chain or a belt.

The balance shaft 10 comprises an eccentric mass or unbalance 42 which makes it possible to obtain the desired compensation for the vibrations due to the movement of the pistons, which are not shown for reasons of clarity.

According to the invention, the balance shaft 10 comprises a cam 16 for interaction with a cam follower roller 18 for a fuel injection pump.

In practice, the internal combustion engine M comprises two balance shafts 10 and each of these balance shafts can be mounted in a freely rotatable manner using a plurality of bearings, at least two of which can be placed on the same side of the cam 16 as shown by dotted lines in FIG. 1.

In the embodiment illustrated in FIG. 1, the bearings 12 and 14 have a double row of rolling elements and each comprise two bearings 12a, 12b; 14a and 14b with one row of rolling elements paired with one another. The bearings 12a, 12b; 14a and 14b with one row of rolling elements are bearings with deep grooves, in particular with three or four points of contact. Alternatively, the bearings are straight-contact or angular-contact bearings. In particular, each of the two bearings 12a, 12b; 14a, 14b with one row of rolling elements comprises a first ring and a second ring manufactured in such a way that there is an axial spacing between the axial surfaces of the first ring and of the second ring, in a configuration without axial forces. The bearings 12a, 12b; 14a and 14b with one row of rolling elements are selected and paired such that the bearings 12a, 12b; 14a and 14b with one row of rolling elements constituting one of the bearings 12, 14 with a double row of rolling elements have complementary axial spacings.

According to one embodiment, the bearings 12 and 14 with a double row of rolling elements are lubricated by a lubricating oil of the internal combustion engine M.

According to one embodiment, the bearings 12 and 14 with a double row of rolling elements are equipped with seals which retain a lubricant, such as an oil or a grease, in a bearing chamber delimited by the seals, this lubricant being put in place before the seals are assembled with the rings of the bearing.

The pairing of the bearings 12a, 12b, 14a and 14b makes it possible to eliminate the noise generated by the operation of the bearings 12 and 14 by suppressing the axial play.

As shown in FIG. 2 for the bearing 12 only, the bearing 12 comprises a first bearing 12a with a single row of balls and a second bearing 12b with a single row of balls. Each of the bearings 12a and 12b respectively comprises one row of balls which is arranged between an inner ring and an outer ring. The bearings 12a and 12b are joined together along an axis of rotation which also corresponds to the longitudinal axis of the bearings 12a and 12b. The inner rings and the outer rings are joined together by surface contact between the lateral faces of the bearing 12a and the lateral faces of the bearing 12b that are opposite the lateral faces of the bearing 12a.

The technical features of the embodiments and variants described above may be combined within the scope of the present invention as defined in the claims.

What is claimed is:

1. A balance shaft adapted to be rotated by a crankshaft of an internal combustion engine, the balance shaft being equipped with:
bearings in order to be mounted in a freely rotatable manner in a frame of the internal combustion engine, and
a cam for interaction with a cam follower roller for a fuel injection pump, wherein at least one of the bearings is a bearing with a double row of rolling elements.

2. The balance shaft according to claim 1,
wherein the at least one bearing comprises two bearings with one row of rolling elements paired with one another.

3. The balance shaft according to claim 2,
wherein each of the two bearings with one row of rolling elements comprises a first ring and a second ring manufactured in such a way that there is an axial spacing between axial surfaces of the first ring and of the second ring in a configuration without axial forces, the bearings with one row of rolling elements being paired in such a way that the bearings with one row of rolling elements constituting at least one of the bearings with a double row of rolling elements have complementary axial spacings.

4. The balance shaft according to claim 1,
wherein the balance shaft comprises a gear with a helical profile.

5. The balance shaft according to claim 1,
wherein the bearings with one row of rolling elements are of the type with deep grooves.

6. The balance shaft according to claim 5,
wherein the bearings are configured comprising one of three or four points of contact.

7. The balance shaft according to claim 5,
wherein the bearings are of a type comprising at least one of:
(a) straight contacts, and
(b) angular contacts.

8. The balance shaft according to claim 1,
wherein the at least one bearing with a double row of rolling elements is lubricated by a lubricating oil of the internal combustion engine.

9. The balance shaft according to claim 1,
wherein the at least one bearing with a double row of rolling elements is equipped with seals which retain a lubricant in a bearing chamber delimited by the seals,
wherein the lubricant is put in place before the seals are assembled with the rings of the bearing.

10. The balance shaft according to claim 9,
wherein the lubricant is one of an oil or a grease.

11. An internal combustion engine comprising:
at least one balance shaft,
each of the at least one balance shaft being equipped with bearings in order to be mounted in a freely rotatable manner in a frame of the internal combustion engine, and with a cam for interaction with a cam follower roller for a fuel injection pump,
wherein at least one of the bearings is a bearing with a double row of rolling elements,
wherein the at least one balance shaft is integrated into the internal combustion engine.

12. A method for assembling an internal combustion engine, the method comprising steps of:
obtaining at least one balance shaft,
each of the at least one balance shaft being equipped with bearings in order to be mounted in a freely rotatable manner in a frame of the internal combustion engine, and with a cam for interaction with a cam follower roller for a fuel injection pump,
wherein at least one of the bearings is a bearing with a double row of rolling elements,
selecting and pairing the bearings with one row of rolling elements in such a way that the bearings with one row of rolling elements constitute at least one of the bearings with a double row of rolling elements, have complementary axial spacings.

13. The method for assembling an internal combustion engine according to claim 12, further comprising a step of:
selecting and pairing the bearings with one row of rolling elements in such a way that, when they are arranged side by side and face against face, form an assembly which has an axial play close to zero and a certain angle of contact between the balls and the raceways in order to be able to function while withstanding both a radial load and an axial load.
